(19) United States
(12) Patent Application Publication
(10) Pub. No.: US 2025/0393103 A1
(43) Pub. Date: Dec. 25, 2025

(54) INDUCTION HEATING DEVICE AND PROGRAM FOR INDUCTION HEATING DEVICE

(71) Applicant: SAMSUNG ELECTRONICS CO., LTD., Suwon-si (KR)

(72) Inventors: Nobuharu NISHIKOORI, Yokohama-shi (JP); Taro YOSHIDA, Yokohama-shi (JP)

(21) Appl. No.: 19/301,448

(22) Filed: Aug. 15, 2025

Related U.S. Application Data
(63) Continuation of application No. PCT/KR2025/008585, filed on Jun. 20, 2025.

(30) Foreign Application Priority Data
Jun. 21, 2024 (JP) 2024-100217

(51) Int. Cl. H05B 6/06; H02M 1/00; H02M 7/539; H05B 6/08; H05B 6/12

(52) U.S. Cl. CPC H05B 6/065; H02M 1/0067; H02M 7/539; H05B 6/08; H05B 6/1272; H05B 2213/05

(57) ABSTRACT

An induction heating device includes a first heating coil and a second heating coil, a first half-bridge circuit connected to an end of the first heating coil, a second half-bridge circuit connected to an end of the second heating coil, a third half-bridge circuit connected to the respective other ends of the first heating coil and the second heating coil, and a control device configured to drive the first half-bridge circuit and the second half-bridge circuit out-of-phase. The control device alternately executes a first mode and a second mode according to a defined time ratio, wherein in the first mode, the second half-bridge circuit and the third half-bridge circuit are controlled to be driven in-phase, and in the second mode, the first half-bridge circuit and the third half-bridge circuit are controlled to be driven in-phase.

### CROSS-REFERENCE TO RELATED APPLICATIONS

This application is a continuation application under, 35 U.S.C. § 111(a), of International Patent Application No. PCT/KR2025/008585, filed on Jun. 20, 2025, which claims priority to Japanese Patent Application No. 2024-100217, filed on Jun. 21, 2024, the content of which in their entirety is herein incorporated by reference.

### TECHNICAL FIELD

The disclosure relates to an induction heating device and a program for the induction heating device.

### BACKGROUND ART

In households or restaurants, heating devices for cooking that use various methods to heat food are being used. Recently, heating devices for cooking that heat a heating object, for example, a cooking vessel such as a pan, by using electricity rather than gas, have been supplied.

Methods of heating a heating object by using electricity are largely classified into a resistance heating method and an induction heating method. An electrical resistance method is a method of heating a heating object by radiating or transferring, through conduction, to a heating object (for example, a cooking vessel), heat generated when currents flow through a metal resistance line or a non-metal heater such as silicon carbide. An induction heating method is a method of causing a heating object to be heated by generating eddy currents in the heating object including a metal component by using a magnetic field generated around a coil when high frequency power of a certain magnitude is applied to the coil. An induction heating device using the induction heating method generally includes a working coil (a heating coil) in each of corresponding areas to heat a plurality of heating objects (cooking vessels), respectively.

An induction heating device is a heating device for cooking that uses an induction heating principle, and is commonly referred to as an induction device, an induction range, or an induction cooking device. The induction heating device has little oxygen consumption compared with a gas range and emits no waste gas, and thus, may reduce indoor air contamination and an indoor temperature rise. Also, the induction heating device uses an indirect method of inducing heat from a heating object, thereby having high energy efficiency and stability, and while the heating object emits heat, a contact surface is not heated, and thus, the risk of burns is low. Recently, the demand for induction heating devices has continuously increased.

### DISCLOSURE

### Technical Solution

An induction heating device according to an embodiment of the disclosure may include a first heating coil and a second heating coil. The induction heating device according to an embodiment of the disclosure may include a first inverter circuit connected to a first end of the first heating coil, and a second inverter circuit connected to a first end of the second heating coil. The induction heating device according to an embodiment of the disclosure may include a third inverter circuit connected to respective second ends of the first heating coil and the second heating coil. The induction heating device according to an embodiment of the disclosure may include a processor configured to drive the first inverter circuit and the second inverter circuit out-of-phase. The processor of the induction heating device according to an embodiment of the disclosure may further be configured to alternately execute a first mode and a second mode according to a defined time ratio, wherein in the first mode, the second inverter circuit and the third inverter circuit may be controlled to be driven in-phase, and in the second mode, the first inverter circuit and the third inverter circuit may be controlled to be driven in-phase.

The induction heating device according to an embodiment of the disclosure may further include a third heating coil including a first end to which the second inverter circuit is connected, and a fourth inverter circuit connected to a second end of the third heating coil.

According to an embodiment of the disclosure, the processor may further be configured to control the third inverter circuit and the fourth inverter circuit to be driven out-of-phase.

According to an embodiment of the disclosure, the processor may further be configured to control the first inverter circuit and the fourth inverter circuit to be driven in-phase in the first mode.

According to an embodiment of the disclosure, the processor may further be configured to control the second inverter circuit and the fourth inverter circuit to be driven in-phase in the second mode.

According to an embodiment of the disclosure, the induction heating device may further include a fourth heating coil including a first end to which the first inverter circuit is connected and a second end to which the fourth inverter circuit is connected.

According to an embodiment of the disclosure, the processor may further be configured to control the second inverter circuit and the third inverter circuit to be driven in-phase and the first inverter circuit and the fourth inverter circuit to be driven in-phase in the first mode.

According to an embodiment of the disclosure, a first phase difference between the first inverter circuit and the second inverter circuit in the first mode may be different from a second phase difference between the first inverter circuit and the second inverter circuit in the second mode.

According to an embodiment of the disclosure, the processor may further be configured to control the first to fourth inverter circuits such that only two heating coils from among the first to fourth heating coils operate in any one mode of the first mode and the second mode.

According to an embodiment of the disclosure, the first inverter circuit, the second inverter circuit, the third inverter circuit, and the fourth inverter circuit may include half-bridge circuits.

According to an embodiment of the disclosure, the processor may further be configured to execute the first mode and the second mode according to a same time ratio and control power supplied to the first heating coil in the first mode and power supplied to the second heating coil in the second mode to be twice as large as a target power supply with respect to each of the first and second heating coils.

According to an embodiment of the disclosure, the processor may further be configured to control the power supplied to the first heating coil in the first mode and the power supplied to the second heating coil in the second mode to be equal to each other.

According to an embodiment of the disclosure, the processor may further be configured to operate the first mode and the second mode according to a time ratio based on a ratio between the target power supply with respect to the first heating coil and the target power supply with respect to the second heating coil.

According to an embodiment of the disclosure, the processor may further be configured to control the time ratio according to which the first mode and the second mode are executed and the power supplied to each of the first and second heating coils in the first mode and the second mode, such that the power supplied to the first heating coil and the second heating coil in the first mode and the power supplied to the first heating coil and the second heating coil in the second mode become equal to each other.

The induction heating device according to an embodiment of the disclosure may further include a connection switch portion including a switch configured to switch connection between each heating coil and the inverter circuit.

According to an embodiment of the disclosure, the processor may further be configured to perform switching between the first mode and the second mode according to a period of a voltage of an alternating current power source connected to each inverter circuit.

According to a method, performed by an induction heating device, of operating a plurality of heating coils, according to an embodiment of the disclosure, the induction heating device may include a first heating coil and a second heating coil, a first inverter circuit connected to a first end of the first heating coil, and a second inverter circuit connected to a first end of the second heating coil.

According to the method, performed by the induction heating device, of operating the plurality of heating coils, according to an embodiment of the disclosure, the induction heating device may include a third inverter circuit connected to respective second ends of the first heating coil and the second heating coil, and a control device.

The method, performed by the induction heating device, of operating the plurality of heating coils, according to an embodiment of the disclosure, may include driving the first inverter circuit and the second inverter circuit out-of-phase.

The method, performed by the induction heating device, of operating the plurality of heating coils, according to an embodiment of the disclosure, may include alternately executing a first mode and a second mode according to a defined time ratio, wherein in the first mode, the second inverter circuit and the third inverter circuit are controlled to be driven in-phase, and in the second mode, the first inverter circuit and the third inverter circuit are controlled to be driven in-phase.

### DESCRIPTION OF DRAWINGS

FIG. 1 is a diagram showing a usage form of an induction heating device according to an embodiment of the disclosure.

FIG. 2 is a diagram for describing an entire structure of an induction heating device according to an embodiment of the disclosure.

FIG. 3 is a diagram showing a structure of a half-bridge circuit according to an embodiment of the disclosure.

FIG. 4 is an explanatory diagram for describing a heating operation controlled by a control device, according to an embodiment of the disclosure.

FIG. 5 is an explanatory diagram for describing electric power control by a control device, according to an embodiment of the disclosure.

FIG. 6A is an explanatory diagram for describing a heating operation controlled by a control device configured to operate three heating coils, according to an embodiment of the disclosure.

FIG. 6B is an explanatory diagram for describing a heating operation controlled by a control device configured to operate two heating coils, according to an embodiment of the disclosure.

FIG. 7 is an explanatory diagram for describing electric power control by a control device, according to an embodiment of the disclosure.

FIG. 8 is a diagram showing a structure of an inverter device operating by including a connection switch portion, according to an embodiment of the disclosure.

FIG. 9 is a block diagram of an induction heating device according to an embodiment of the disclosure.

FIG. 10 is a flow diagram illustrating a method of operating an induction heating device according to an embodiment of the disclosure.

### MODE FOR INVENTION

The terms used in the disclosure will be briefly described, and an embodiment of the disclosure will be described in detail.

The terms used in the disclosure are general terms as possible that have been widely used nowadays in consideration of the functions in the disclosure, which, however, may be changed according to an intention of a technician in the art, a precedent, the advent of new technologies, or the like. Also, particular cases may include terms arbitrary selected by an applicant, and in this case, the meaning of the terms will be described in detail in the corresponding description. Therefore, the terms used in the disclosure should be defined based on the meanings of the terms and the content throughout the disclosure, rather than simply based on the titles of the terms.

Throughout the disclosure, the expression “at least one of a, b or c” may indicate “a,” “b,” “c,” “a and b,” “a and c,” “b and c,” “all of a, b, and c,” or variations thereof.

Throughout the disclosure, when a part “includes” or “comprises” an element, the part may further include other elements, not excluding the other elements, unless there is a particular description contrary thereto. Also, terms such as “unit,” “module,” etc. used in the disclosure denote a unit that processes at least one function or operation, and the “unit,” and the “module” may be embodied in a hardware manner, a software manner, or a combination of the hardware manner and the software manner.

Combinations of blocks in each of flowcharts and the flowcharts shall be understood to be performed by one or more computer programs including computer-executable instructions. All of the one or more computer programs may be stored in a single memory or may be separately stored in a plurality of different memories.

Unless clearly otherwise indicated in context, the singular expressions “a,” “an,” and “the” shall be understood to include a plurality of objects. Thus, for example, the expression “a component surface” may also indicate one or more of those surfaces.

All of the functions or operations described in this disclosure may be processed by one processor or a combination of processors. The one processor or the combination of the processors may refer to circuitry and may include the circuitry, such as an application processor (AP) a communication processor (CP), a graphical processing unit (GPU), a neural processing unit (NPU), a microprocessor unit (MPU), a system on chip (SoC), an integrated chip (IC), etc.

Hereinafter, an embodiment of the disclosure will be described in detail with reference to the accompanying drawings, so that one of ordinary skill in the art may easily execute the embodiment of the disclosure. However, an embodiment of the disclosure may have different forms and should not be construed as being limited to the embodiment of the disclosure described herein. Also, in the drawings, parts not related to descriptions are omitted for the clear description of an embodiment of the disclosure, and throughout the specification, like reference numerals are used for like elements.

When a plurality of heating coils are simultaneously used for heating in an induction heating device, a large current generated by summing currents flowing through the plurality of heating coils may flow through one reference half-bridge circuit, and switching loss may increase in the reference half-bridge circuit.

Thus, in order to solve this problem, the disclosure aims to provide an induction heating device capable of reducing switching loss when a heating object is heated by using a plurality of heating coils.

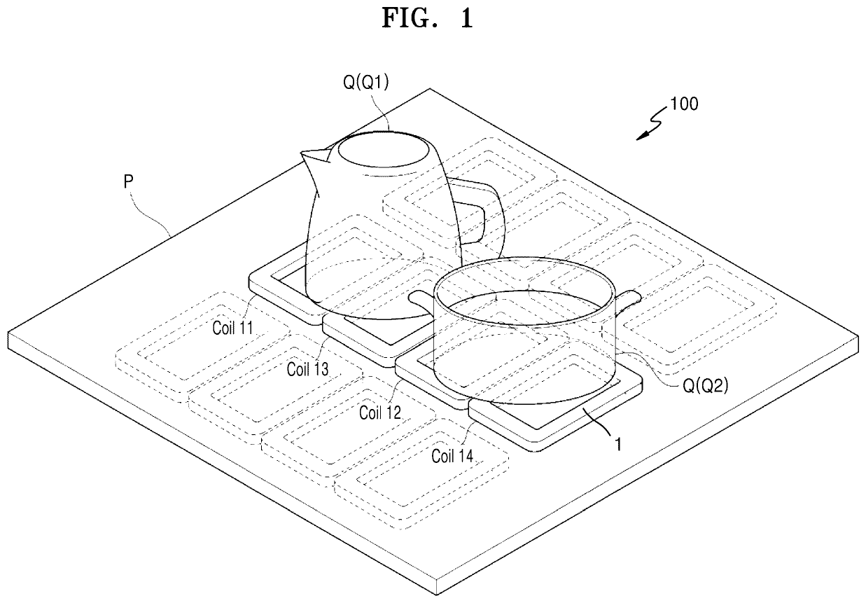

FIG. 1 is a diagram for describing a usage form of an induction heating device 100 according to an embodiment of the disclosure.

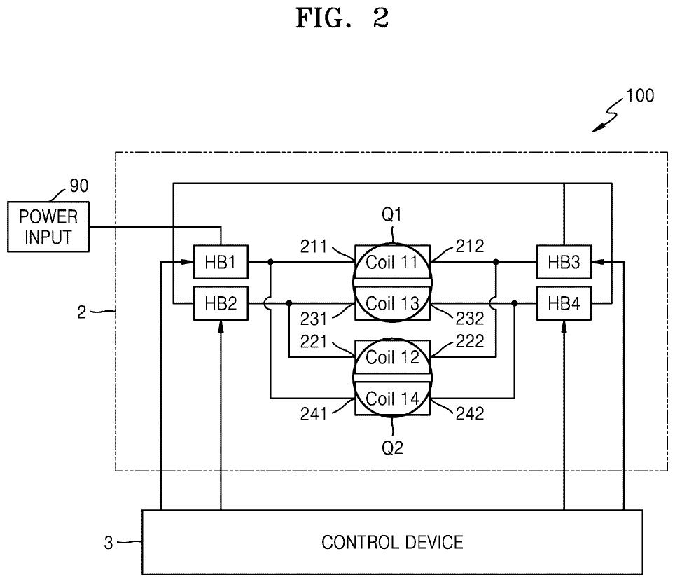

Also, FIG. 2 is a diagram showing an entire structure of the induction heating device 100 according to an embodiment of the disclosure.

The induction heating device 100 according to an embodiment of the disclosure may perform induction heating on a heating object, such as a cooking pan placed on a top plate, etc., by using a plurality of heating coils.

The induction heating device 100 according to an embodiment of the disclosure may include a top plate P on which a heating object Q is placed, a heating coil 1 configured to perform induction heating on the heating object Q, an inverter device 2 configured to supply power to the heating coil 1, and a control device 3 configured to control the inverter device 2, as illustrated in FIGS. 1 and 2.

The induction heating device 100 may further include a position detection sensor (not shown) configured to detect a position of the heating object Q placed on the top plate P, a current detector (not shown) configured to detect currents supplied to the inverter device 2, and a voltage detector (not shown) configured to detect voltages supplied to the inverter device 2 from a commercial power source.

The top plate P may include a flat mounting surface on which the heating object Q is placed, as illustrated in FIG. 1. The top plate P may include a flat including an electrically insulating material, such as glass or ceramic.

The heating coil 1 may be mounted on a lower inner side of the top plate P as illustrated in FIGS. 1 and 2. The heating coil 1 may include a plurality of heating coils. FIG. 1 illustrates the total of twelve heating coils, wherein four heating coils 1 are mounted in a row, with there being three total rows. Hereinafter, the four heating coils 1 are to be referred to as a first heating coil 11, a second heating coil 12, a third heating coil 13, and a fourth heating coil 14.

Here, the four heating coils 1 are serially arranged in the order of the first heating coil 11, the third heating coil 13, the second heating coil 12, and the fourth heating coil 14. The arrangement of the heating coils 1 may have the shape of a two-dimensional array. Each of the first heating coil 11, the second heating coil 12, the third heating coil 13, and the fourth heating coil 14 is only referred to as a unit driven by a half-bridge circuit, and may not necessarily denote a heating coil corresponding to one cooker. For example, each of the first to fourth heating coils 11 to 14 may include a plurality of heating coils connected in series or may include heating coils driven in parallel.

The heating coil 1 may have a sheet shape mounted on a substrate. In detail, the heating coil 1 may include a printed circuit board (PCB) including a photoresist, etc. Here, each of the plurality of heating coils 1 is illustrated to have the same shape and size. However, the shape and size of each of the heating coils 1 may be appropriately changed. Also, the heating coil 1 may include a coil wound by Litz wire, rather than a PCB.

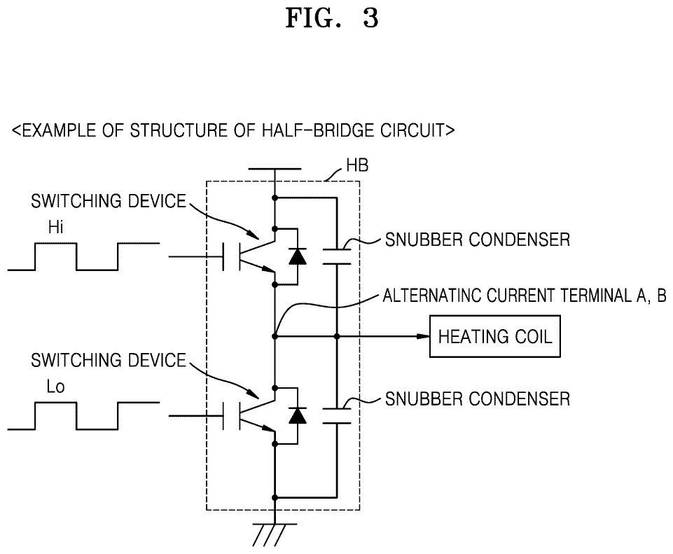

The inverter device 2 may be configured to convert a voltage supplied from commercial power, such as electricity from an electrical grid, into high frequency power and to supply the high frequency power to each heating coil 1. Here, the inverter device 2 may include four half-bridge circuits HB included in two full-bridge-type inverter circuits. The half-bridge circuits HB are described with reference to FIG. 3.

FIG. 3 is a diagram showing a structure of a half-bridge circuit HB according to an embodiment of the disclosure.

The half-bridge circuit HB may include two switching devices as illustrated in FIG. 3. The switching device may include an insulated gate bipolar transistor (IGBT), a field-effect transistor (FET), a metal oxide semiconductor field-effect transistor (MOSFET), a transistor (TR), etc., but is not limited thereto. To prevent damage to the switching devices due to high currents, which can be generated by parasitic inductance when the switching devices are turned off, a snubber condenser may be mounted between a drain and a source of each of the switching devices. A first end or a second end of the heating coil 1 may be connected to an alternating current terminal mounted between the two switching devices of the half-bridge circuit HB.

A first half-bridge circuit HB1 and a second half-bridge circuit HB2 from among the four half-bridge circuits HB may be connected to the first end of the heating coil 1, and a third half-bridge circuit HB3 and a fourth half-bridge circuit HB4 may be connected to the second end of the heating coil 1.

Each half-bridge circuit HB may be connected to two heating coils 1. In detail, as illustrated in FIG. 2, the first half-bridge circuit HB1 may be connected to the first end 211 of the first heating coil 11 and the first end 241 of the fourth heating coil 14, the second half-bridge circuit HB2 may be connected to the first end 221 of the second heating coil 12 and the first end 231 of the third heating coil 13, the third half-bridge circuit HB3 may be connected to the second end 212 of the first heating coil 11 and the second end 222 of the second heating coil 12, and the fourth half-bridge circuit HB4 may be connected to the second end 232 of the third heating coil 13 and the second end 242 of the fourth heating coil 14.

Based on this structure, according to an embodiment of the disclosure, there may be combinations of two half-bridge circuits HB with each of the four heating coils 1 between the two half-bridge circuits, and these combinations may form four different types of full-bridge-type inverter circuits. For example, one full-bridge-type inverter circuit may be formed by the first half-bridge circuit HB1 and the third half-bridge circuit HB3 with the first heating coil 11 therebetween.

FIG. 3 illustrates the four half-bridge circuits HB configured to drive the heating coils 1. However, the disclosure is not limited thereto. For example, in the circuit diagram illustrated in FIG. 2, each half-bridge circuit may be a type of inverter circuit, and thus, each half-bridge circuit may be each different type of inverter circuit configured to perform the same function. For example, each half-bridge circuit may be substituted by a full-bridge circuit or a different type of inverter circuit. Accordingly, according to the disclosure, the first to fourth half-bridge circuits HB1 to HB4 may be included in first to fourth inverter circuits INVI to INV4, respectively, capable of performing the same functions.

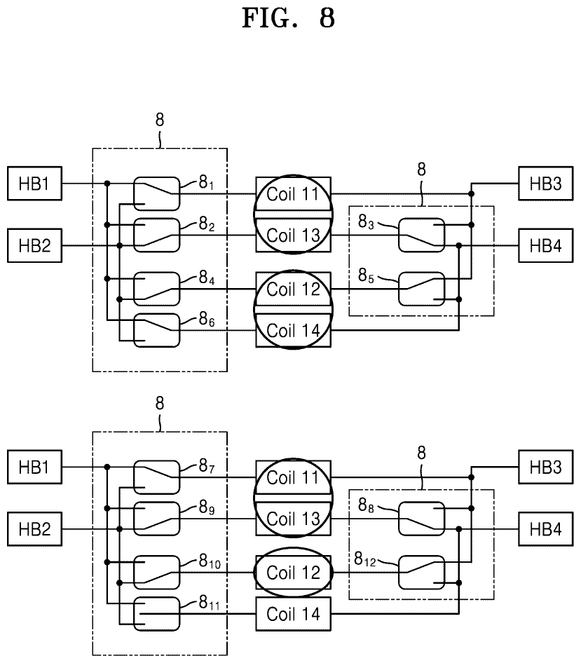

Referring to FIG. 8, the inverter device 2 may include a connection switch portion 8 configured to switch a connection/disconnection state between each heating coil 1 and a full-bridge-type inverter circuit corresponding to the heating coil 1. According to an embodiment of the disclosure, the connection switch portion 8 may be mounted for each heating coil 1. The connection switch portion 8 may include a switch 8₁₋₁₂ controlled by the control device 3. The switch 8₁₋₁₂ included in the connection switch portion 8 may include an electronic switch. The electronic switch may include a relay switch and an electronic control switch, such as a TR, an IGBT, an FET, an MOSFET. The connection/non-connection of the full-bridge-type inverter circuit through the connection switch portion 8 will be described in detail below.

Referring to FIGS. 1 and 2 again, the control device 3 may physically include a central processing unit (CPU), a memory, an input device, etc. The control device 3 may functionally operate such that the CPU or a peripheral device may cooperate according to a program stored in the memory, thereby controlling each half-bridge circuit HB1, HB2, HB3, or HB4 and the connection switch portion 8.

The control device 3 may be configured to control power (a power supply) provided to each heating coil from the inverter device 2. In detail, the control device 3 may be configured to control power supplied to each heating coil by controlling an operation of the full-bridge-type inverter circuit corresponding to each heating coil 1 by transmitting, to the inverter device 2, a control signal to control on and off states of the switching device included in each half-bridge circuit HB.

According to an embodiment of the disclosure, the control device 3 may control a driving frequency of the power supply by using, for example, a pulse frequency modulation (PFM) control method. Also, a specific control method is not limited to the PFM control method, but may also include a pulse width modulation (PWM) control method.

Hereinafter, a heating operation and an electric power control operation performed by the control device 3 when a heating object is heated by using four heating coils 1 are described.

First, a heating operation of the induction heating device 100 is described.

Here, as illustrated in FIG. 2, a case where two heating objects Q1 and Q2 are heated by using the first to fourth heating coils 11 to 14 is described. For convenience, a heating object corresponding to the heating object Q1 in FIG. 2 may be referred to as a first heating object, and a heating object corresponding to the heating object Q2 in FIG. 2 may be referred to as a second heating object. In this case, the control device 3 may alternately execute, according to a defined time ratio, a first mode and a second mode. In the first mode, power is supplied to the first heating coil 11 and the third heating coil 13 corresponding to the first heating object Q1. In the second mode, power is supplied to the second heating coil 12 and the fourth heating coil 14 corresponding to the second heating object Q2.

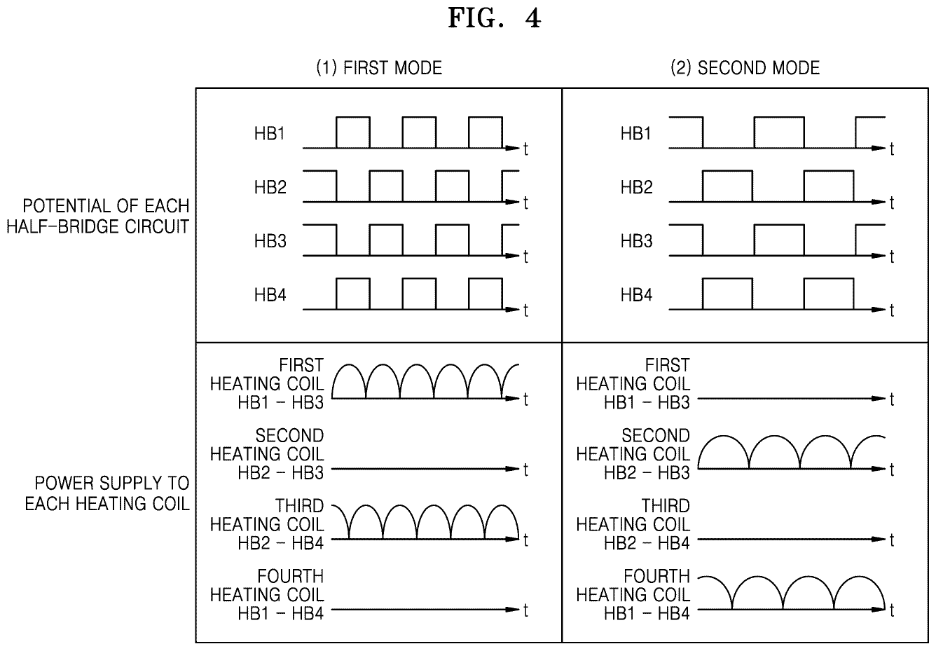

Hereinafter, the first mode and the second mode are described in more detail. First, as illustrated in (1) the first mode and (2) the second mode of FIG. 4, the control device 3 may drive the first half-bridge circuit HB1 and the second half-bridge circuit HB2 out-of-phase through the first mode and the second mode and may drive the third half-bridge circuit HB3 and the fourth half-bridge circuit HB4 out-of-phase through the first mode and the second mode. Here, the phrase “out-of-phase” may refer to misalignment between a timing at which on and off states of two switching devices included in a half-bridge circuit at one side are changed and a timing at which on and off states of two switching devices included in a half-bridge circuit at the other side are changed.

FIG. 4 is an explanatory diagram for describing the heating operation controlled by the control device 3, according to an embodiment of the disclosure.

Here, two half-bridge circuits (for example, the first half-bridge circuit HB1 and the second half-bridge circuit HB2) driven out-of-phase may be driven in inverse-phase (the phase difference=about 180 degrees). Also, when the two half-bridge circuits are driven out-of-phase, the phase difference is not limited to the value described above and may include all phase differences to be out-of-phase. Also, for example, a phase difference between the first half-bridge circuit HB1 and the second half-bridge circuit HB2 may be different between the first mode and the second mode, as illustrated in FIG. 4.

According to an embodiment of the disclosure, the control device 3 may control the two half-bridge circuits HB2 and HB3 connected to the second heating coil 12 to be driven in-phase and control the two half-bridge circuits HB1 and HB4 connected to the fourth heating coil 14 to be driven in-phase, in the first mode.

According to an embodiment of the disclosure, the control device 3 may control the two half-bridge circuits HB1 and HB3 connected to the first heating coil 11 to be driven in-phase and control the two half-bridge circuits HB2 and HB4 connected to the third heating coil 13 to be driven in-phase, in the second mode.

In each mode, by driving the two half-bridge circuits HB connected to the certain heating coil 1 in-phase (the phase difference=0 degrees) not to generate a potential difference, power may not be supplied to the corresponding heating coil 1.

By doing so, when a heating object is heated by using the first to fourth heating coils 11 to 14, power may be supplied in the first mode only to the first heating coil 11 and the third heating coil 13 from among the four heating coils 1, and power may be supplied in the second mode only to the second heating coil 12 and the fourth heating coil 14. In other words, according to an embodiment of the disclosure, the control device 3 may control the first to fourth half-bridge circuits HB1 to HB4 such that only two heating coils from among the first to fourth heating coils 11 to 14 may operate in any one mode of the first mode and the second mode.

According to an embodiment of the disclosure, the control device 3 may perform switching between the first mode and the second mode according to a period of a voltage of alternating current power, in order to reduce the load to the switching devices caused by the mode switching.

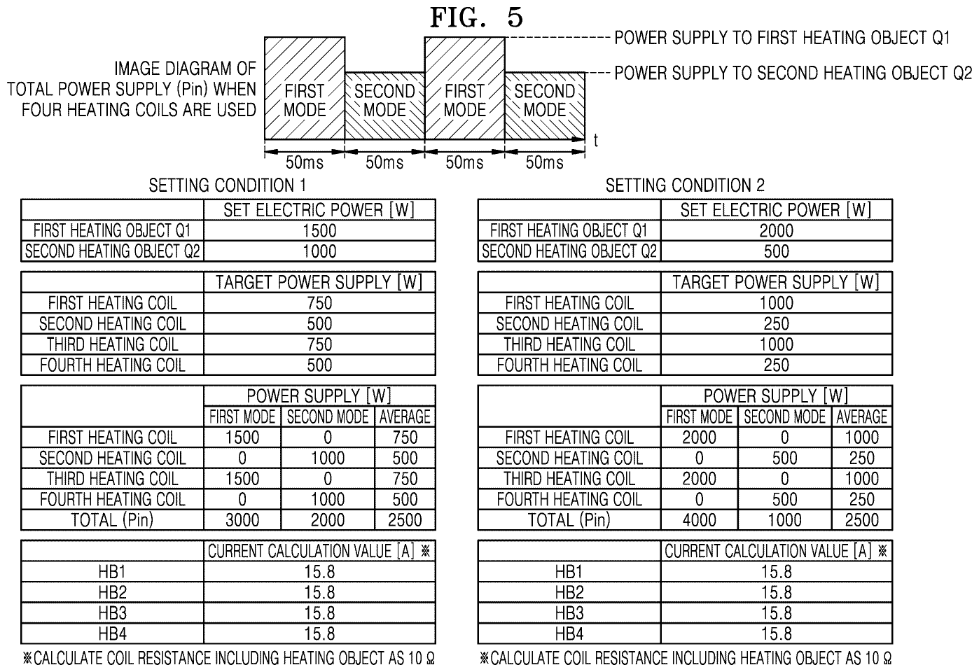

Hereinafter, the electric power control operation during the heating operation is described. For convenience of explanation, as illustrated in FIG. 2, a case where the first heating object Q1 of the two heating objects is heated by the electric power of 1500 W, and the second heating object Q2 is heated by the electric power of 1000 W, is described as an example (see setting condition 1 of FIG. 5).

In this case, in order to uniformly heat the heating objects, a target power supply of each of the first heating coil 11 and the third heating coil 13 configured to heat the first heating object Q1 may be set to be 750 W, and likewise, a target power supply of each of the second heating coil 12 and the fourth heating coil 14 configured to heat the second heating object Q2 may be set to be 500 W. Here, the target power supply indicates power to be supplied to each heating coil 1, which is set according to the electric power set with respect to the heating object.

In order to provide the target power supply set as described above, the control device 3 according to an embodiment of the disclosure may execute the first mode and the second mode by the same time ratio (1:1) and also, may provide twice as large as the target power supply of each heating coil 1 to the first heating coil 11 and the third heating coil 13 in the first mode and to the second heating coil 12 and the fourth heating coil 14 in the second mode.

For example, as illustrated in FIG. 5, the control device 3 may alternately perform the first mode and the second mode by an interval of 50 msec. The control device 3 may control the power of 1500 W to be supplied to each of the first heating coil 11 and the third heating coil 13 in the first mode and control the power of 1000 W to be supplied to each of the second heating coil 12 and the fourth heating coil 14 in the second mode, so as to provide the target power supply to each heating coil 1.

Also, when the two heating objects Q1 and Q2 are heated by the same electric power, or one heating object is heated by using the four heating coils 11 to 14, the control device 3 may control the time ratio between the first mode and the second mode and the power supply to each heating coil 1 in each mode, such that the power amount supplied to each heating coil 1 through the first mode and the second mode may become equal.

Hereinafter, switching loss of the inverter device 2 of the induction heating device 100 according to an embodiment of the disclosure is assessed. Currents flowing through each half-bridge circuit when a heating object is heated by using four heating coils 1, according to the heating operation described above and the set electric power (the setting condition 1 of FIG. 5), are calculated.

Assuming that the impedance of each heating coil is the same, the following equation may be established, with respect to the total power supply Pin [W], which is the sum of power supplied to a plurality of heating coils, when a heating object is heated by using the plurality of heating coils.

$$Pin = n \times {I}^{∧} 2 \times R$$

n: the number of heating coils
I: (currents [A] flowing through each heating coil)
R: coil resistance including the heating object [Ω]

Assuming that the total power supply Pin provided to the heating coils through the first mode and the second mode is 2500 W, the number of heating coils n is 4, and the coil resistance is 10Ω, the average of the currents I flowing through the heating coils 1 may be calculated as 7.9 A, based on the equation above. Also, each half-bridge circuit may be connected to both of the heating coil driven in the first mode and the heating coil driven in the second mode, and thus, the currents flowing through the heating coils may be equally 15.8 A.

Also, even when the electric power set to each heating object is changed as in setting condition 2 of FIG. 5, the currents flowing through each half-bridge circuit may become equal (here, 15.8 A), when the total power supply Pin is the same (here 2500 W).

In the induction heating device 100 according to an embodiment of the disclosure, the heating coils 11 and 13 driven in the first mode and the heating coils 12 and 14 driven in the second mode may be connected to the half-bridge circuits HB1 to HB4, based on one-to-one correspondence, and thus, the currents flowing through each half-bridge circuit HB1, HB2, HB3, or HB4 may be reduced compared with a case where two heating coils simultaneously driven are connected to the half-bridge circuit, and thus, switching loss may be reduced.

Also, the power supplied to the two heating coils 1 in each mode is controlled to be equal, and thus, when the currents flowing through the four half-bridge circuits HB are equal, the switching loss in each half-bridge circuit HB may be equal. Thus, the load to each half-bridge circuit HB may become equal to stabilize the lifespan of a product.

The first mode and the second mode are executed by a time sharing manner, and thus, even when power of a different diving frequency is supplied to the heating coil 1 in each mode, resonance sound due to the different driving frequency may also be prevented.

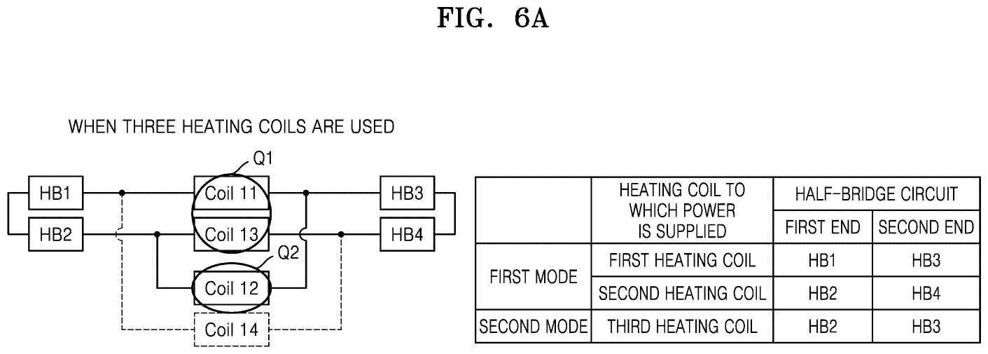

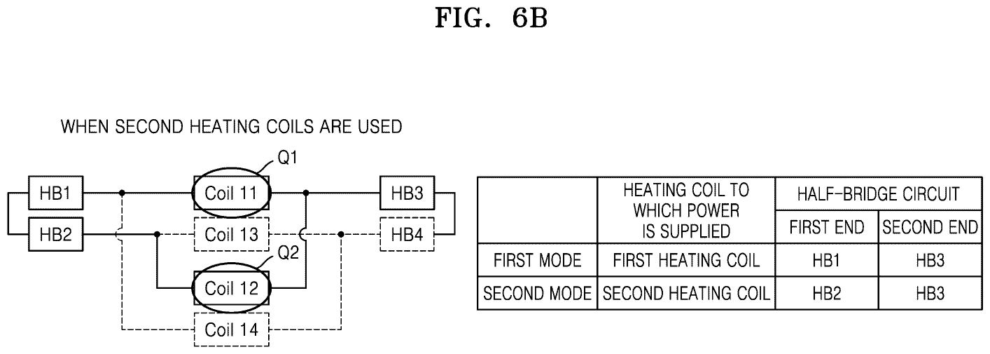

FIG. 6A is an explanatory diagram for describing a heating operation controlled by the control device 3 configured to operate three heating coils, according to an embodiment of the disclosure.

According to an embodiment of the disclosure, the heating operation controlled by the control device 3 when a heating object is heated by using three or less heating coils, is described.

As illustrated in FIG. 6A, the operation of heating the first and second heating objects Q1 and Q2 by using the first to third heating coils 11 to 13 are described. In this case, the control device 3 may alternately perform a first mode in which power is supplied to the first heating coil 11 and the third heating coil 13 and a second mode in which power is supplied to the second heating coil 12, according to a defined time ratio.

According to an embodiment of the disclosure, the control device 3 may control the connection switch portion 8 such that the first half-bridge circuit HB1 or the fourth half-bridge circuit HB4 may not be connected to the fourth heating coil 14. Also, the control device 3 may drive each half-bridge circuit according to the same method as the case using the four heating coils described above. Accordingly, the control device 3 may supply power only to the first heating coil 11 and the third heating coil 13 from among the three heating coils 1 in the first mode and supply power only to the second heating coil 12 in the second mode.

According to this heating operation, the control device 3 may alternately operate two heating coils connected to each of the second half-bridge circuit HB2 and the third half-bridge circuit HB3, and thus, compared with a case where the heating coils are simultaneously driven, currents flowing through the two half-bridge circuits may be reduced, and thus, switching loss may be reduced.

FIG. 6B is an explanatory diagram for describing a heating operation controlled by the control device 3 configured to operate two heating coils, according to an embodiment of the disclosure.

Next, the case where the two heating coils are used is described. As illustrated in FIG. 6B, the operation of heating the first and second heating objects Q1 and Q2 by using the first and second heating coils 11 and 12 is described. According to an embodiment of the disclosure, the control device 3 may alternately perform a first mode in which power is supplied to the first heating coil 11 and a second mode in which power is supplied to the second heating coil 12, according to a defined time ratio.

The control device 3 may control the connection switch portion 8 such that corresponding half-bridge circuits are not connected to the third heating coil 13 and the fourth heating coil 14. Also, the control device 3 may drive the two half-bridge circuits HB1 and HB2 out-of-phase through the first mode and the second mode. Next, the control device 3 may control the two half-bridge circuits HB2 and HB3 to be driven in-phase in the first mode and control the two half-bridge circuits HB1 and HB3 to be driven in-phase in the second mode. Thus, the induction heating device 100 may supply power only to the first heating coil 11 of the two heating coils 1 in the first mode and supply power only to the second heating coil 12 in the second mode.

By performing this heating operation, currents flowing through the third half-bridge circuit HB3 may be reduced compared with a case where the first heating coil 11 and the second heating coil 12 are simultaneously driven, and thus, switching loss may be reduced.

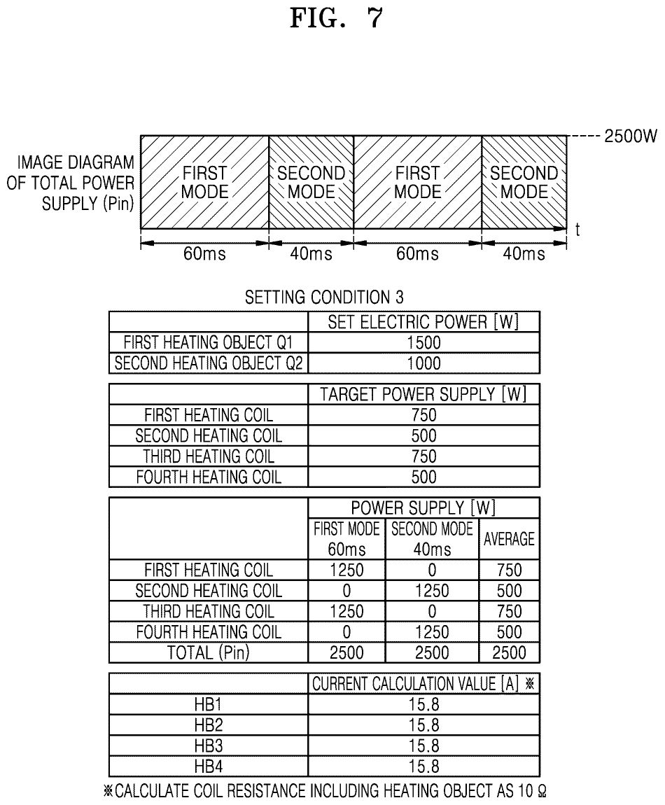

FIG. 7 is an explanatory diagram for describing electric power control by the control device 3, according to an embodiment of the disclosure. The control device 3 according to an embodiment of the disclosure may operate a first mode and a second mode according to a different time ratio. In detail, the control device 3 may uniformly control the power supplied to each heating coil 1 in each mode and may also execute the first mode and the second mode according to a time ratio corresponding to a ratio between a target power supply with respect to the heating coil in the first mode and a target power supply with respect to the heating coil in the second mode.

According to an embodiment of the disclosure, as illustrated in FIG. 2, when the first heating object Q1 is heated by 1500 W and the second heating object Q2 is heated by 1000 W (see setting condition 3 of FIG. 7), the control device 3 may control the power supplied to each heating coil in each mode to be 1250 W and may also execute the first mode and the second mode based on the time ratio of 6:4.

As described above, even when the control device 3 performs the electric power control operation by adjusting the time ratio with respect to each mode, the currents flowing through each half-bridge circuit HB may become equal, when the total power supply Pin is the same.

Thus, the total power supply Pin obtained by calculating the average of the two modes may be maximized within a power limit limited by a breaker, etc.

For example, it is assumed that there is a power limit whereby a breaker operates when the total power supply Pin with respect to the induction heating device 100 exceeds 2500 W. When a method whereby the time ratio between the first mode and the second mode is the same is used, the breaker may operate because the total power supply Pin in the first mode exceeds 3000 W when it is aimed to realize the target power supply indicated in the setting condition 1 of FIG. 5. On the contrary, when a method whereby the time ratio between the first mode and the second mode is set to be different from each other is used, the breaker may not operate because the total power supply Pin in each mode does not exceed 2500 W when it is aimed to realize the same target power supply (see setting condition 3 of FIG. 7).

FIG. 8 is a diagram showing a structure of the inverter device 2 configured to operate by including the connection switch portion 8, according to an embodiment of the disclosure. According to an embodiment of the disclosure, the connection switch portion 8 of the inverter device 2 may be configured to switch connection between each heating coil and the half-bridge circuit HB, as illustrated in FIG. 8. Also, according to an embodiment of the disclosure, the control device 3 may specifically determine a position and a size of a heating object placed on the top plate P, based on an output of a position detection sensor, and based on the position, may control the connection switch portion 8 to switch a connection state of the half-bridge circuit HB to heat the heating object Q.

According to an embodiment of the disclosure, when the control device 3 determines, based on the position or the size of the heating object, that it is necessary to use two or more heating coils, the control device 3 may switch the connection state of the half-bridge circuit HB to heat the corresponding heating object Q through the heating operation. Thus, each of the plurality of half-bridge circuits (or one half-bridge circuit) may be connected to two heating coils.

According to an embodiment of the disclosure, when the plurality of heating coils 1 are used, the currents flowing through each half-bridge circuit may become uniform regardless of a combination of the plurality of heating coils 1, and thus, the total switching loss may be reduced.

According to an embodiment of the disclosure, the control device 3 may control the power supplied to four heating coils by controlling driving of four half-bridge circuits. However, the number of heating coils and the number of half-bridge circuits controlled by the control device 3 are not limited to the example described above.

The control device 3 may control the power supplied to two heating coils by controlling driving of at least three half-bridge circuits. In detail, when a heating object is heated by using two heating coils connected to one half-bridge circuit, the control device 3 may alternately perform a first mode in which two half-bridge circuits connected to a first heating coil are driven in-phase and a second mode in which two half-bridge circuits connected to a second heating coil are driven in-phase, according to a defined time ratio.

The control device 3 may execute, between the first mode and the second mode, a third mode in which the driving method of each half-bridge circuit is different from the first mode and the second mode. In the third mode, the control device 3, for example, may stop the driving of all of the half-bridge circuits or may drive all of the half-bridge circuits out-of-phase.

In addition, the disclosure may be employed by a wireless power transfer device including a power transmission coil rather than a heating coil. In this case also, the induction heating device 100 may control driving of at least three half-bridge circuits and may control power supplied to two feeding coils in a time sharing manner.

As described above, according to the disclosure, an induction heating device which may reduce switching loss by heating a heating object by using a plurality of heating coils may be provided.

According to the disclosure, all or at least part of the operations performed by the control device 3 may be executed by a processor included in the control device 3.

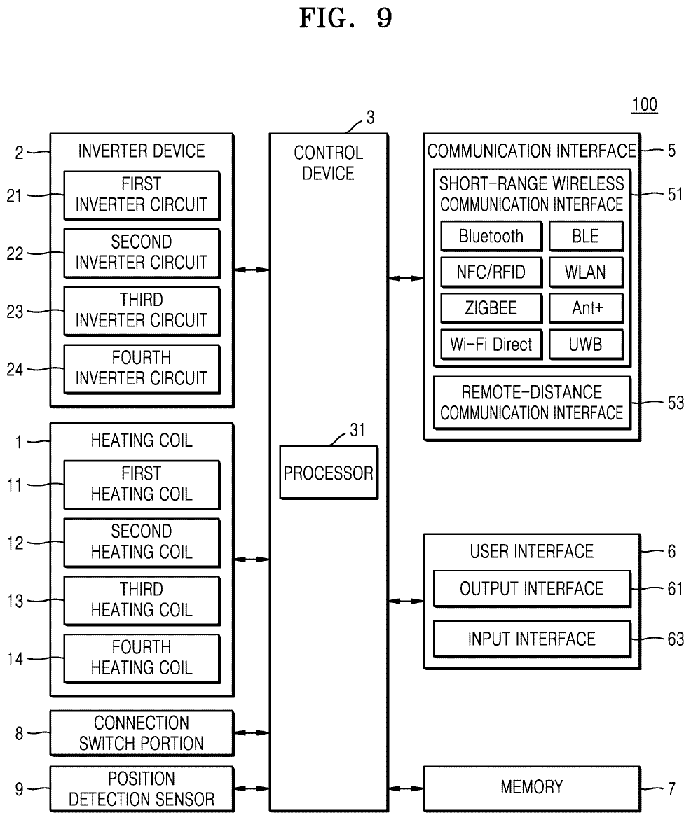

FIG. 9 is a block diagram of the induction heating device 100 according to an embodiment of the disclosure.

As illustrated in FIG. 9, the induction heating device 100 according to an embodiment of the disclosure may include the heating coil 1, the inverter device 2, the control device 3, a communication interface 5, a user interface 6, a memory 7, the connection switch portion 8, and a position detection sensor 9. According to an embodiment of the disclosure, some of the components, for example, the communication interface 5, the connection switch portion 8, and the position detection sensor 9, may not be included in the induction heating device 100.

Hereinafter, the components above are sequentially described.

The heating coil 1 may include the first heating coil 11, the second heating coil 12, the third heating coil 13, and the fourth heating coil 14, but is not limited thereto. As described above with reference to an embodiment of the disclosure, the heating coil 1 may include only two heating coils or may include more than two heating coils. When the number of heating coils increases, the number of inverter circuits in the inverter device 2 may also increase.

The heating coil 1 may be realized as a PCB on which patterns are printed or may be wound by Litz wire. The heating coil 1 may generate a magnetic field for heating the heating object Q. For example, when a driving current is supplied to the heating coil 1, a magnetic field may be induced around the heating coil 1. When the heating coil 1 is supplied with a current, the magnitude and the direction of which change according to time, that is, an alternating current, a magnetic field, the magnitude and the direction of which change according to time, may be induced around the heating coil 1. The magnetic field around the heating coil 1 may pass through a top plate including tempered glass and may reach the heating object Q placed on the top plate. Due to the magnetic field, the magnitude and the direction of which change according to time, an eddy current rotating based on the magnetic field may occur in the heating object Q, and due to the eddy current, electrical resistance heat may be generated in the heating object Q. The electrical resistance heat, which is generated in a resistor when a current flows in the resistor, may also be referred to as Joule heat. The heating object Q may be heated by the electrical resistance heat.

The inverter device 2 may include a plurality of inverter circuits, namely, a first inverter circuit 21, a second inverter circuit 22, a third inverter circuit 23, and a fourth inverter circuit 24, but is not limited thereto. The inverter device 2 may include less than four inverter circuits or more than four inverter circuits.

Each inverter circuit may include a half-bridge circuit including two switching devices connected in series, but is not limited thereto. Each inverter circuit may include any type of inverter circuit configured to allow alternating currents to flow through the heating coil 1.

The connection switch portion 8 may be used to switch connection between each inverter circuit included in the inverter device 2 and each heating coil included in the heating coil 1. Detailed aspects about the connection switch portion 8 are described with reference to FIG. 8, and thus, they are not described in detail.

The position detection sensor 9 may be used to detect the heating object Q placed on the top plate P of the induction heating device 100. The position detection sensor 9 may detect a position and a size of the heating object Q.

The control device 3 may receive data through interaction with the heating coil 1, the inverter device 2, the connection switch portion 8, the position detection sensor 9, the communication interface 5, the user interface 6, and the memory 7 and may control each component of the induction heating device 100. According to an embodiment of the disclosure, a processor 31 of the control device 3 may perform this control function.

The processor 31 may control the overall operations of the induction heating device 100. The processor 31 may include a hardware device configured to control the overall operations of the induction heating device 100. The processor 31 may include a hardware chip including an integrated circuit in which electrical circuits are integrated.

The processor 31 may include various processing circuits and/or a plurality of processors. For example, the term “processor” used herein including the claims may include various processing circuits including at least one processor. At least one of the one or more processors may be configured to perform various functions described herein, separately in a distributed fashion and/or collectively. As used herein, the “processor, the “at least one processor,” and the “one or more processors” may be configured to perform various functions. However, these terms may, without limit, cover a situation in which one processor may perform some of functions and (an) other processor(s) may perform others of the functions and a situation in which a single processor may perform all functions. Also, the at least one processor may include a combination of processors configured to perform various functions from among the functions described herein in a distributed fashion. The at least one processor may be configured to execute program instructions to achieve or perform various functions. The processor 31 may execute programs stored in the memory 7 to control the inverter device 2, the communication interface 5, the user interface 6, and the memory 7. The induction heating device 100 may include at least one processor. For example, the processor 31 may include one processor or a plurality of processors. The induction heating device 100 may include only a main processor or may include a main processor and at least one sub-processor.

According to an embodiment of the disclosure, the induction heating device 100 may load an artificial intelligence (AI) processor. The AI processor may be loaded on the induction heating device 100 in the form of an AI-dedicated hardware chip or in the form of a portion of a previous general-purpose processor (for example, a CPU or an application processor) or a graphics dedicated processor (for example, a GPU).

The processor 31 may determine a switching frequency (a turn on/off frequency) of each inverter circuit of the inverter device 2, based on an output intensity (a power level) of the induction heating device 100. The processor 31 may generate a driving control signal for turning on/turning off a switching circuit included in the inverter circuit according to a time ratio between a first mode and a second mode and the determined switching frequency. According to an embodiment of the disclosure, the processor 31 may control the inverter device 2 to apply a gate signal to each of the half-bridge circuits in the first mode and the second mode as illustrated in FIG. 4. The induction heating device 100 may include a separate driving processor from the processor 31, in order to control an operation of the inverter device 2 from among the operations of the processor 31.

The communication interface 5 may include one or more components for enabling communication between the induction heating device 100 and the heating object Q, between the induction heating device 100 and a server device (not shown), or between the induction heating device 100 and a user terminal (not shown). For example, the communication interface 5 may include a short-range wireless communication interface 51 and a remote-distance communication interface 53. The short-range wireless communication interface 51 may include a Bluetooth communication interface, a Bluetooth low energy (BLE) communication interface, a near-field communication interface, a wireless local area network (WLAN) (or WiFi) communication interface, a Zigbee communication interface, an infrared data association (IrDA) communication interface, a WiFi direct (WFD) communication interface, an ultra-wideband (UWB) communication interface, an Ant+communication interface, etc., but is not limited thereto. When the heating object Q is remotely controlled by a server device (not shown) in an Internet of things (IoT) environment, the remote-distance communication interface 53 may be used for communication with the server device. The remote-distance communication interface 53 may include the Internet, a computer network (for example, a local area network (LAN) or a wide area network (WAN)), or a mobile communicator. The mobile communicator may transceive a wireless signal with at least one of a base station, an external terminal, or a server on a mobile communication network. Here, the wireless signal may include a sound call signal, a video-telephony call signal, or data of various forms according to transmission and reception of text/a multimedia message. The mobile communicator may include a 3^{rd} generation (3G) module, a 4^{th} generation (4G) module, a long term evolution (LTE) module, a 5^{th} generation (5G) module, a 6^{th} generation (6G) module, an NB-IoT module, an LTE-M module, etc., but is not limited thereto.

The user interface 6 may include an output interface 61 and an input interface 63. The output interface 61 may be configured to output an audio signal or a video signal and may include a display and a sound outputter.

When the display and a touch pad are layered to form a touch screen, the display may be used not only as the output interface 61, but also as the input interface 63. The display may include at least one of a liquid crystal display, a thin-film transistor-liquid crystal display, a light-emitting diode (LED), an organic LED, a flexible display, a three-dimensional (3D) display, or an electrophoretic display. Also, according to a form in which the induction heating device 100 is realized, the induction heating device 100 may include at least two displays.

The sound outputter may output audio data received from the communication interface 5 or stored in the memory 7. Also, the sound outputter may output a sound signal related to a function performed by the induction heating device 100. The sound outputter may include a speaker, a buzzer, etc.

According to an embodiment of the disclosure, the output interface 51 may display information about the heating object Q. For example, the output interface 51 may output a graphical user interface (GUI) corresponding to identification information or product type information of the heating object Q. Also, the output interface 61 may output information about a current position of the heating object Q.

The input interface 63 may be configured to receive an input from a user. The input interface 63 may include at least one of a key pad, a dome switch, a touch pad (a touch capacitance method, a pressure resistive-layer method, an infrared sensing method, a surface ultrasonic conduction method, an integral tension measurement method, a piezo effect method, etc.), a jog wheel, or a jog switch, but is not limited thereto.

The input interface 63 may include a sound recognition module. For example, the induction heating device 100 may receive a sound signal, which is an analog signal, through a microphone and may convert a sound portion into computer-readable text by using an automatic speech recognition (ASR) model. The induction heating device 100 may interpret the converted text by using a natural language understanding (NLU) model and may obtain an intention of an utterance of a user. Here, the ASR model or the NLU model may be an AI model. The AI model may be processed by an AI-dedicated processor designed to have a hardware structure specialized for processing an AI model. The AI model may be formed through training. Here, to be formed through training denotes that a basic AI model is trained by using a plurality of pieces of training data through a training algorithm, so that a predefined operation rule or an AI model configured to perform a desired feature (or an objective) is formed. The AI model may include a plurality of neural network layers. The plurality of neural network layers may respectively have a plurality of weight values and may perform calculation using a calculation result of a previous layer and calculation between the plurality of weight values.

Language understanding is technique to recognize and apply/process human languages/letter and may include natural language processing, machine translation, dialog system, question answering, speech/recognition/synthesis, etc.

The memory 7 may store a program for processing and controlling by the processor 31 and may store input/output data (For example, unique identification information of the heating object Q, data about a time ratio between the first mode and the second mode, a plurality of power transmission patterns, information about a cooking proceeding situation with respect to the heating object Q, a target power supply, etc.). The memory 7 may store an AI model.

The memory 7 may include at least one type of storage medium from a flash memory-type storage medium, a hard disk-type storage medium, a multimedia card micro-type storage medium, a card-type memory (for example, SD or XD memory), random-access memory (RAM), static RAM (SRAM), read-only memory (ROM), electrically erasable programmable ROM (EEPROM), programmable ROM (PROM), a magnetic memory, a magnetic disk, or an optical disk. Also, the induction heating device 100 may operate a web storage or a cloud server performing a storage function on the Internet.

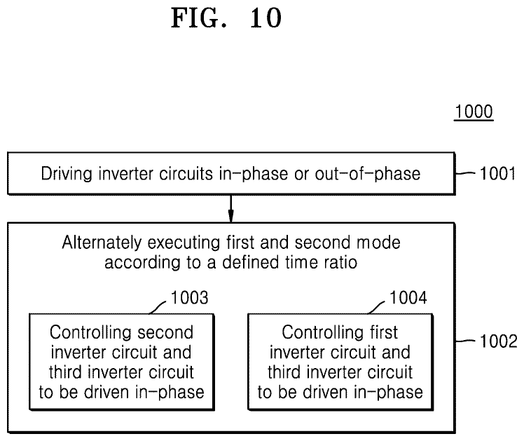

With reference to FIG. 10, a method 1000 is provided and is to be performed by an induction heating device as described herein. The method 1000 operates a plurality of heating coils, wherein the induction heating device includes a first heating coil and a second heating coil, a first inverter circuit connected to a first end of the first heating coil, a second inverter circuit connected to a first end of the second heating coil, a third inverter circuit connected to respective second ends of the first heating coil and the second heating coil and a control device. The method 1000 includes driving the first inverter circuit and the second inverter circuit out-of-phase (block 1001) and alternately executing a first mode and a second mode according to a defined time ratio (block 1002). In the first mode, the executing of block 1002 includes controlling the second inverter circuit and the third inverter circuit to be driven in-phase (block 1003). In the second mode, the executing of block 1002 includes controlling the first inverter circuit and the third inverter circuit to be driven in-phase (block 1004).

In accordance with an embodiment, the executing of block 1002 can include executing the first mode and the second mode according to a same time ratio and, in these or other cases, the method 1001 can further include controlling power supplied to the first heating coil in the first mode to be twice as large as a target power supply with respect to the first heating coil and controlling power supplied to the second heating coil in the second mode to be twice as large as a target power supply with respect to the second heating coil and/or controlling the power supplied to the first heating coil in the first mode and the power supplied to the second heating coil in the second mode to be equal to each other.

In accordance with an embodiment, the executing of block 1002 can include executing the first mode and the second mode according to a time ratio based on a ratio between the target power supply with respect to the first heating coil and the target power supply with respect to the second heating coil, controlling the time ratio according to which of the first mode and the second mode is executed and controlling the power supplied to each of the first and second heating coils in the first mode and the second mode such that the power supplied to the first heating coil and the second heating coil in the first mode and the power supplied to the first heating coil and the second heating coil in the second mode become equal to each other.

In accordance with an embodiment, the induction heating device can further include a connection switch portion including a switch configured to switch a connection between each heating coil and the inverter circuit. In these or other cases, the method 1001 can further include switching between the first mode and the second mode according to a period of a voltage of an alternating current power source connected to each inverter circuit.

The induction heating device 100 according to an embodiment of the disclosure may include a first heating coil and a second heating coil. The induction heating device 100 according to an embodiment of the disclosure may include a first inverter circuit connected to a first end of the first heating coil, and a second inverter circuit connected to a first end of the second heating coil. The induction heating device 100 according to an embodiment of the disclosure may include a third inverter circuit connected to respective second ends of the first heating coil and the second heating coil. The induction heating device 100 according to an embodiment of the disclosure may include a processor configured to drive the first inverter circuit and the second inverter circuit out-of-phase. The processor of the induction heating device 100 according to an embodiment of the disclosure may further be configured to alternately execute a first mode and a second mode according to a defined time ratio, wherein in the first mode, the second inverter circuit and the third inverter circuit may be controlled to be driven in-phase, and in the second mode, the first inverter circuit and the third inverter circuit may be controlled to be driven in-phase.

The induction heating device 100 according to an embodiment of the disclosure may further include a third heating coil including a first end to which the second inverter circuit is connected, and a fourth inverter circuit connected to a second end of the third heating coil.

According to an embodiment of the disclosure, the processor may further be configured to control the third inverter circuit and the fourth inverter circuit to be driven out-of-phase.

According to an embodiment of the disclosure, the processor may further be configured to control the first inverter circuit and the fourth inverter circuit to be driven in-phase in the first mode.

According to an embodiment of the disclosure, the processor may further be configured to control the second inverter circuit and the fourth inverter circuit to be driven in-phase in the second mode.

According to an embodiment of the disclosure, the induction heating device 100 may further include a fourth heating coil including a first end to which the first inverter circuit is connected and a second end to which the fourth inverter circuit is connected.

According to an embodiment of the disclosure, the processor may further be configured to control the second inverter circuit and the third inverter circuit to be driven in-phase and the first inverter circuit and the fourth inverter circuit to be driven in-phase in the first mode.

According to an embodiment of the disclosure, a first phase difference between the first inverter circuit and the second inverter circuit in the first mode may be different from a second phase difference between the first inverter circuit and the second inverter circuit in the second mode.

According to an embodiment of the disclosure, the processor may further be configured to control the first to fourth inverter circuits such that only two heating coils from among the first to fourth heating coils operate in any one mode of the first mode and the second mode.

According to an embodiment of the disclosure, the first inverter circuit, the second inverter circuit, the third inverter circuit, and the fourth inverter circuit may include half-bridge circuits.

According to an embodiment of the disclosure, the processor may further be configured to execute the first mode and the second mode according to a same time ratio and control power supplied to the first heating coil in the first mode and power supplied to the second heating coil in the second mode to be twice as large as a target power supply with respect to each of the first and second heating coils.

According to an embodiment of the disclosure, the processor may further be configured to control the power supplied to the first heating coil in the first mode and the power supplied to the second heating coil in the second mode to be equal to each other.

According to an embodiment of the disclosure, the processor may further be configured to operate the first mode and the second mode according to a time ratio based on a ratio between the target power supply with respect to the first heating coil and the target power supply with respect to the second heating coil.

According to an embodiment of the disclosure, the processor may further be configured to control the time ratio according to which the first mode and the second mode are executed and the power supplied to each of the first and second heating coils in the first mode and the second mode, such that the power supplied to the first heating coil and the second heating coil in the first mode and the power supplied to the first heating coil and the second heating coil in the second mode become equal to each other.

The induction heating device 100 according to an embodiment of the disclosure may further include a connection switch portion including a switch configured to switch connection between each heating coil and the inverter circuit.

According to an embodiment of the disclosure, the processor may further be configured to perform switching between the first mode and the second mode according to a period of a voltage of an alternating current power source connected to each inverter circuit.

According to a method, performed by an induction heating device, of operating a plurality of heating coils, according to an embodiment of the disclosure, the induction heating device may include a first heating coil and a second heating coil, a first inverter circuit connected to a first end of the first heating coil, and a second inverter circuit connected to a first end of the second heating coil.

According to the method, performed by the induction heating device, of operating the plurality of heating coils, according to an embodiment of the disclosure, the induction heating device may include a third inverter circuit connected to respective second ends of the first heating coil and the second heating coil, and a control device.

The method, performed by the induction heating device, of operating the plurality of heating coils, according to an embodiment of the disclosure, may include driving the first inverter circuit and the second inverter circuit out-of-phase.

The method, performed by the induction heating device, of operating the plurality of heating coils, according to an embodiment of the disclosure, may include alternately executing a first mode and a second mode according to a defined time ratio, wherein in the first mode, the second inverter circuit and the third inverter circuit are controlled to be driven in-phase, and in the second mode, the first inverter circuit and the third inverter circuit are controlled to be driven in-phase.

According to an embodiment of the disclosure, the method, performed by the induction heating device, of executing the first mode and the second mode according to a same time ratio. In an embodiment, the method includes controlling power supplied to the first heating coil in the first mode to be twice as large as a target power supply with respect to the first heating coil. In an embodiment, the method includes controlling power supplied to the second heating coil in the second mode to be twice as large as a target power supply with respect to the second heating coil.

According to an embodiment of the disclosure, the method, performed by the induction heating device, includes controlling the power supplied to the first heating coil in the first mode and the power supplied to the second heating coil in the second mode to be equal to each other.

According to an embodiment of the disclosure, the method, performed by the induction heating device, includes executing the first mode and the second mode according to a time ratio based on a ratio between the target power supply with respect to the first heating coil and the target power supply with respect to the second heating coil. In an embodiment, the method includes controlling the time ratio according to which of the first mode and the second mode is executed. In an embodiment, the method includes controlling the power supplied to each of the first and second heating coils in the first mode and the second mode such that the power supplied to the first heating coil and the second heating coil in the first mode and the power supplied to the first heating coil and the second heating coil in the second mode become equal to each other.

According to an embodiment of the disclosure, the induction heating device further includes a connection switch portion including a switch configured to switch a connection between each heating coil and the inverter circuit. In an embodiment, the method further includes switching between the first mode and the second mode according to a period of a voltage of an alternating current power source connected to each inverter circuit.

The method according to an embodiment of the disclosure may be implemented in the form of a program command executable by various computer devices and may be recorded on a computer-readable medium. The computer-readable medium may include a program command, a data file, a data structure, etc. individually or in a combined fashion. The program command recorded on the medium may be specially designed and configured for the disclosure or may be well known to and usable by one of ordinary skill in the art. Examples of the computer-readable recording medium include magnetic media (e.g., hard discs, floppy discs, or magnetic tapes), optical media (e.g., compact disc-read only memories (CD-ROMs), or digital versatile discs (DVDs)), magneto-optical media (e.g., floptical discs), and hardware devices that are specially configured to store and carry out program commands (e.g., ROMs, random-access memories (RAMs), or flash memories). Examples of the program commands include a high-level language code executable by a computer by using an interpreter, etc., as well as a machine language code, such as the one made by a complier.

The embodiment of the disclosure may also be realized in the form of a recording medium including instructions executable by a computer, such as a program module executed by a computer. A computer-readable medium may include an arbitrary available medium accessible by a computer and includes all of a volatile medium, a non-volatile medium, a detachable medium, and a non-detachable medium. Also, the computer-readable recording medium may include both of a computer storage medium and a communication medium. The computer storage medium may include all of a volatile medium, a non-volatile medium, a detachable medium, and a non-detachable medium realized by an arbitrary method or technique for storing a computer-readable instruction, a data structure, a program module, or information such as other data. The communication medium typically includes computer-readable instructions, data structures, program modules, or other data of modulated data signals, such as carrier waves, or other transmission mechanisms, and includes an arbitrary data transmission mechanism. Also, an embodiment of the present disclosure may also be implemented by a computer program or a computer program product including a computer-executable instruction, such as a computer program executable by a computer.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment of the disclosure, the method according to an embodiment of the disclosure may be provided as an inclusion of a computer program product. The computer program product may be transacted between a seller and a purchaser as a product. The computer program product may be distributed in the form of a machine-readable storage medium (e.g., a CD-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

In addition, the disclosure is not limited to the embodiment of the disclosure described above and may allow various modifications within a range not deviating from the purpose of the disclosure.

1. An induction heating device comprising:
a first heating coil;
a second heating coil;
a first inverter circuit connected to a first end of the first heating coil;
a second inverter circuit connected to a first end of the second heating coil;
a third inverter circuit connected to respective second ends of the first heating coil and the second heating coil; and
a processor configured to drive the first inverter circuit and the second inverter circuit out-of-phase,
wherein the processor is further configured to alternately execute a first mode and a second mode according to a defined time ratio, and wherein:
in the first mode, the processor controls the second inverter circuit and the third inverter circuit to be driven in-phase, and,
in the second mode, the processor controls the first inverter circuit and the third inverter circuit to be driven in-phase.

2. The induction heating device of claim 1, further comprising:
a third heating coil comprising a first end to which the second inverter circuit is connected; and
a fourth inverter circuit connected to a second end of the third heating coil,
wherein the processor is further configured to control the third inverter circuit and the fourth inverter circuit to be driven out-of-phase.

3. The induction heating device of claim 2, wherein the processor is further configured to control the first inverter circuit and the fourth inverter circuit to be driven in-phase in the first mode.

4. The induction heating device of claim 2, wherein the processor is further configured to control the second inverter circuit and the fourth inverter circuit to be driven in-phase in the second mode.

5. The induction heating device of claim 2, further comprising a fourth heating coil comprising a first end to which the first inverter circuit is connected and a second end to which the fourth inverter circuit is connected,
wherein the processor is further configured to control the second inverter circuit and the third inverter circuit to be driven in-phase and the first inverter circuit and the fourth inverter circuit to be driven in-phase in the first mode.

6. The induction heating device of claim 5, wherein the processor is further configured to control the first to fourth inverter circuits such that only two heating coils from among the first to fourth heating coils operate in any one mode of the first mode and the second mode.

7. The induction heating device of claim 2, wherein a first phase difference between the first inverter circuit and the second inverter circuit in the first mode is different from a second phase difference between the first inverter circuit and the second inverter circuit in the second mode.

8. The induction heating device of claim 7, wherein the first inverter circuit, the second inverter circuit, the third inverter circuit, and the fourth inverter circuit comprise half-bridge circuits.

9. The induction heating device of claim 1, wherein the processor is further configured to execute the first mode and the second mode according to a same time ratio, to control power supplied to the first heating coil in the first mode to be twice as large as a target power supply with respect to the first heating coil, and to control power supplied to the second heating coil in the second mode to be twice as large as a target power supply with respect to the second heating coil.

10. The induction heating device of claim 9, wherein the processor is further configured to control the power supplied to the first heating coil in the first mode and the power supplied to the second heating coil in the second mode to be equal to each other.

11. The induction heating device of claim 10, wherein the processor is further configured to execute the first mode and the second mode according to a time ratio based on a ratio between the target power supply with respect to the first heating coil and the target power supply with respect to the second heating coil.

12. The induction heating device of claim 11, wherein the processor is further configured to control the time ratio according to which of the first mode and the second mode is executed and to control the power supplied to each of the first and second heating coils in the first mode and the second mode such that the power supplied to the first heating coil and the second heating coil in the first mode and the power supplied to the first heating coil and the second heating coil in the second mode become equal to each other.

13. The induction heating device of claim 12, further comprising a connection switch portion comprising a switch configured to switch a connection between each heating coil and the inverter circuit.

14. The induction heating device of claim 13, wherein the processor is further configured to perform switching between the first mode and the second mode according to a period of a voltage of an alternating current power source connected to each inverter circuit.

15. An induction heating device comprising:
heating coils;
inverter circuits operably connected to the heat coils;
a position detection sensor configured to detect a position of a heating object placed over one or more of the heating coils; and
a processor configured to drive the inverter circuits in phase and out of phase with one another in accordance with readings of the position of the heating object received from the position detection sensor.

16. A method, performed by an induction heating device, of operating a plurality of heating coils, the induction heating device comprising:
a first heating coil and a second heating coil;
a first inverter circuit connected to a first end of the first heating coil;
a second inverter circuit connected to a first end of the second heating coil;
a third inverter circuit connected to respective second ends of the first heating coil and the second heating coil; and
a control device,
the method comprising:
driving the first inverter circuit and the second inverter circuit out-of-phase; and
alternately executing a first mode and a second mode according to a defined time ratio, wherein:
in the first mode, controlling the second inverter circuit and the third inverter circuit to be driven in-phase, and,
in the second mode, controlling the first inverter circuit and the third inverter circuit to be driven in-phase.

17. The method of claim 16, wherein:
the executing of the first mode and the second mode comprises executing the first mode and the second mode according to a same time ratio, and
the method further comprises:
controlling power supplied to the first heating coil in the first mode to be twice as large as a target power supply with respect to the first heating coil; and
controlling power supplied to the second heating coil in the second mode to be twice as large as a target power supply with respect to the second heating coil.

18. The method of claim 17, further comprising controlling the power supplied to the first heating coil in the first mode and the power supplied to the second heating coil in the second mode to be equal to each other.

19. The method of claim 18, further comprising:
executing the first mode and the second mode according to a time ratio based on a ratio between the target power supply with respect to the first heating coil and the target power supply with respect to the second heating coil;
controlling the time ratio according to which of the first mode and the second mode is executed; and
controlling the power supplied to each of the first and second heating coils in the first mode and the second mode such that the power supplied to the first heating coil and the second heating coil in the first mode and the power supplied to the first heating coil and the second heating coil in the second mode become equal to each other.

20. The method of claim 19, wherein:
the induction heating device further comprises a connection switch portion comprising a switch configured to switch a connection between each heating coil and the inverter circuit, and
the method further comprises switching between the first mode and the second mode according to a period of a voltage of an alternating current power source connected to each inverter circuit.
